(19) United States
(12) Patent Application Publication
(10) Pub. No.: US 2008/0318630 A1
(43) Pub. Date: Dec. 25, 2008

(54) GRACEFUL COEXISTENCE FOR MULTIPLE COMMUNICATION PROTOCOLS

(75) Inventor: Amit Gil, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/767,771

(22) Filed: Jun. 25, 2007

(51) Int. Cl. H04Q 7/20

(52) U.S. Cl. 455/561

(57) ABSTRACT

Techniques for graceful coexistence of modules supporting multiple communication protocols are described. Graceful coexistence may be achieved by giving priority to a communication protocol having high priority data to send or receive. In one design, the priority of data to send via a wireless channel by a first module for a first communication protocol (e.g., IEEE 802.11) may be determined, e.g., based on data type, one or more data protocol header fields, an application originating the data, etc. Whether to send the data without delay may be decided based on the priority of the data. A second module for a second communication protocol (e.g., Bluetooth) may be requested to not transmit on the wireless channel in response to a decision to send the data without delay. The data may be sent via the wireless channel upon receiving an indication that the wireless channel is not occupied by the second module.

### BACKGROUND

I. Field

The present disclosure relates generally to communication, and more specifically to techniques for operating a terminal that supports multiple communication protocols.

II. Background

Many electronics devices support multiple communication protocols, which may also be referred to as radio technologies or air interfaces. For example, a laptop computer may use a wireless personal area network (WPAN) to connect to a wireless mouse, a wireless keyboard, etc. The laptop computer may also have a module for communication with wireless local area networks (WLANs), which have become increasingly popular and are commonly deployed at various public and private locations. A mobile device such as a cellular phone or a personal digital assistant (PDA) may also support multiple communication protocols such as cellular, WLAN, and WPAN. The mobile device may use WPAN to communicate with an earpiece and/or other devices. The mobile device may also be capable of providing email and Internet access as well as traditional cellular communication via the supported communication protocols.

A WPAN may utilize a communication protocol such as Bluetooth, which is a short-range communication protocol adopted as IEEE 802.15 by the Institute for Electrical and Electronic Engineers (IEEE). Bluetooth has an operating range of approximately ten meters. A WLAN may utilize any of the medium-range communication protocols in the IEEE 802.11 family of standards.

Some communication protocols operate on the same frequency band. For example, Bluetooth, 802.11, 802.11b and 802.11g operate in the Industrial, Scientific and Medical (ISM) band between 2.4 giga-Hertz (GHz) and 2.4835 GHz. Bluetooth utilizes frequency hopping spread spectrum (FHSS). A Bluetooth module may send transmissions on 1 mega-Hertz (MHz) bandwidth that hops at a rate of 1600 times per second across up to 79 MHz in the ISM band. A WLAN module may implement 802.11b/g and may operate on a fixed frequency channel, which may be one of three non-overlapping frequency channels in the ISM band. In 802.11b/g, each frequency channel is 22 MHz for direct sequence spread spectrum (DSSS) or 16.7 MHz for orthogonal frequency division multiplexing (OFDM).

A WLAN module and a Bluetooth module may coexist within a terminal (e.g., a laptop computer, a cellular phone, etc.) and may be in close proximity to one another. Coexistence of the WLAN and Bluetooth modules may entail using the same antenna, being located on the same circuit board or coupled circuit boards, being located on the same integrated circuit chip or coupled chip sets, being located within the same terminal, etc. If the WLAN and Bluetooth modules are both operational, then a Bluetooth transmission might be sent on a frequency channel used by the WLAN module and would then interfere with a WLAN transmission.

When the WLAN and Bluetooth modules coexist, a signal transmitted from one module may saturate a low noise amplifier (LNA) in a receiver of the other module, which may then cause the receiver to be desensitized. For example, if the WLAN module is receiving data at the same time that the Bluetooth module is transmitting, then the transmit power of the Bluetooth module may spill into the receiver of the WLAN module and desensitize the receiver. The desensitization of the receiver may cause degradation in performance, loss of data, failure in communication, and/or other deleterious effects. The converse is true when the Bluetooth module is receiving data at the same time that the WLAN module is transmitting.

There is therefore a need in the art for techniques to avoid deleterious effects due to interference when a WLAN module and a Bluetooth module coexist.

### SUMMARY

Techniques for graceful coexistence of modules supporting multiple communication protocols, e.g., IEEE 802.11 and Bluetooth, are described herein. Graceful coexistence may be achieved by giving priority to a communication protocol having high priority data to send or receive via a wireless channel. In such an instance, other communication protocol(s) may be requested to not transmit on the wireless channel in order for this communication protocol to send or receive the high priority data.

In one design, data to send via a wireless channel by a first module for a first communication protocol (e.g., IEEE 802.11) may be received. The priority of the data may be determined, e.g., based on data type, one or more header fields of one or more data protocols used for the data, an application originating the data, etc. Whether to send the data without delay may be decided based on the priority of the data. A second module for a second communication protocol (e.g., Bluetooth) may be requested to not transmit on the wireless channel in response to a decision to send the data without delay. The data may be sent via the wireless channel upon receiving an indication that the wireless channel is not occupied by the second module.

In another design, priority of data to receive via the wireless channel by the first module may be determined. Whether to gain control of the wireless channel may be decided based on the priority of the data. The second module may be requested to not transmit on the wireless channel in response to a decision to gain control of the wireless channel in order to receive the data via the first module.

Various aspects and features of the disclosure are described in further detail below.

### BRIEF DESCRIPTION OF THE DRAWINGS

FIG. 1 shows a deployment of a WWAN, a WLAN, and two WPANs.

FIG. 2 shows a block diagram of a terminal and an access point.

FIG. 3 shows a WLAN module and a Bluetooth module.

FIG. 4 shows data encapsulation for different data protocols.

FIG. 5 shows a process for sending data.

FIG. 6 shows a process for receiving data.

### DETAILED DESCRIPTION

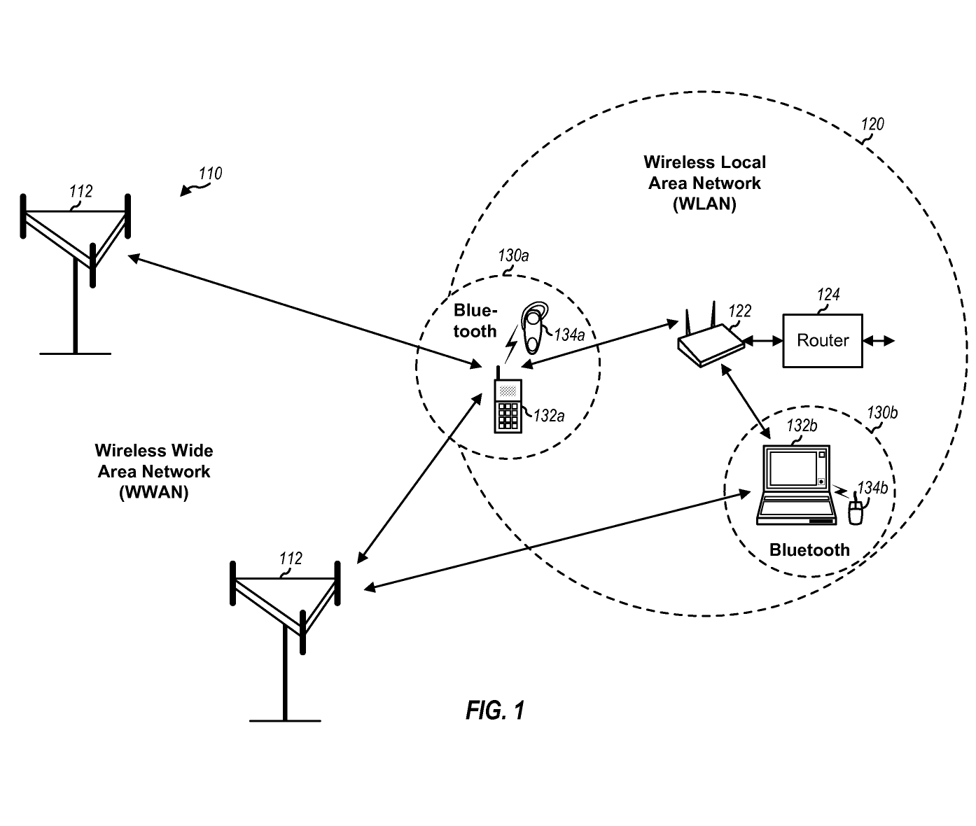

FIG. 11 shows an exemplary deployment of a wireless wide area network (WWAN) 110, a WLAN 120, and WPANs 130a and 130b. WWAN 110 provides communication coverage for a large geographic area such as, e.g., a city, a state, or an entire country. WWAN 110 may be a cellular network such as a Code Division Multiple Access (CDMA) network, a Time Division Multiple Access (TDMA) network, a Frequency Division Multiple Access (FDMA) network, an Orthogonal FDMA (OFDMA) network, etc. A CDMA network may utilize a communication protocol such as cdma2000 or Wideband CDMA (W-CDMA). cdma2000 covers IS-95, IS-2000, and IS-856 standards. A TDMA network may utilize a communication protocol such as Global System for Mobile Communications (GSM). These various communication protocols and standards are known in the art. WWAN 110 typically includes many base stations 112 that support communication for terminals within the coverage area of the WWAN. For simplicity, only two base stations 112 are shown in FIG. 1. A base station is generally a fixed station that communicates with the terminals and may also be referred to as a base transceiver station (BTS), a Node B, an evolved Node B (eNode B), etc.

WLAN 120 provides communication coverage for a medium geographic area such as, e.g., a building, a home, etc. WLAN 120 may include any number of access points that support communication for any number of stations. For simplicity, only one access point 122 is shown in FIG. 1. WLAN stations may communicate with access point 122 and/or with each other via peer-to-peer communication. WLAN 120 may implement IEEE 802.11, 802.11b, 802.11g and/or other standards. Access point 122 may couple to a router 124, which may exchange data packets with a local area network (LAN), a wide area network (WAN), the Internet, etc. Access point 122 and router 124 may also be combined in a single wireless router.

WPANs 130a and 130b provide communication coverage for small geographic areas. In the example shown in FIG. 1, WPAN 130a supports communication between a cellular phone 132a and a headset 134a. WPAN 130b provides wireless connectivity between a laptop computer 132b and a mouse 134b. In general, each WPAN may include any number of WPAN devices. WPANs 130a and 130b may implement Bluetooth.

A terminal may be able to communicate with one or more wireless networks. A terminal may also be referred to as a mobile station, an access terminal, a user terminal, a user equipment, a mobile equipment, a subscriber unit, a station, etc. A terminal may be a cellular phone, a laptop computer, a PDA, a wireless device, a wireless modem, a mobile device, a handset, a handheld device, a smart phone, a cordless phone, a satellite radio, etc. In the example shown in FIG. 1, cellular phone 132a is a terminal that can communicate with WWAN 110, WLAN 120 and WPAN 130a. Laptop computer 132b is a terminal that can communicate with WWAN 110, WLAN 120 and WPAN 130b. A terminal may thus be a WWAN device (e.g., a cellular phone), a WLAN station, and a Bluetooth device.

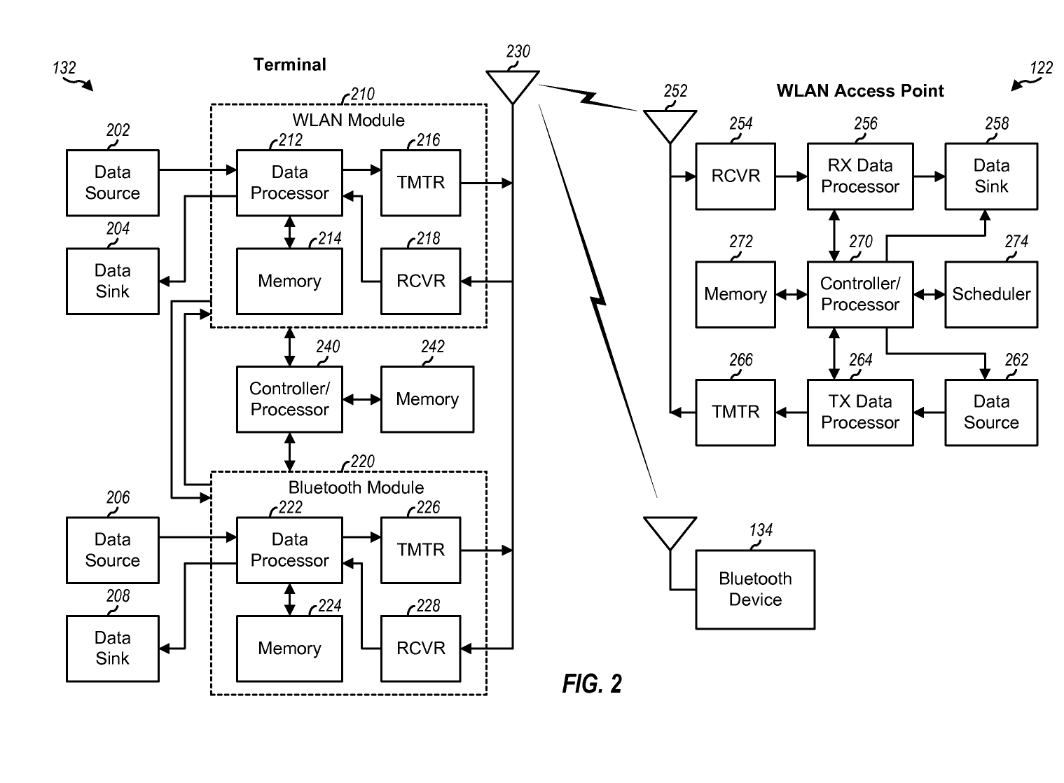

FIG. 2 shows a block diagram of a design of a terminal 132 and access point 122. Terminal 132 may be cellular phone 132a or laptop computer 132b in FIG. 1. Terminal 132 includes a WLAN module 210 that supports communication with WLANs and a Bluetooth module 220 that supports communication with Bluetooth devices. Terminal 132 may also have a WWAN module that supports communication with WWAN 110. This WWAN module is not shown in FIG. 2 for simplicity.

For WLAN operation, a data processor 212 receives traffic data from a data source 202 and signaling data from a controller/processor 240. Data processor 212 processes (e.g., encodes, interleaves, modulates, and scrambles) the traffic and signaling data and generates data chips. A transmitter (TMTR) 216 conditions (e.g., converts to analog, amplifies, filters, and frequency upconverts) the data chips and generates an uplink signal, which is transmitted via an antenna 230 to access point 122. A memory 214 stores data and program codes for WLAN module 210.

At access point 122, an antenna 252 receives the uplink signals from terminal 132 and other terminals and provides a received signal to a receiver (RCVR) 254. RCVR 254 conditions (e.g., amplifies, filters, frequency downconverts, and digitizes) the received signal and provides samples. A receive (RX) data processor 256 processes (e.g., descrambles, demodulates, deinterleaves, and decodes) the samples and provides decoded data to a data sink 258. On the downlink, a transmit (TX) data processor 264 receives traffic data from a data source 262 and signaling data from a controller/processor 270. TX data processor 264 processes the traffic and signaling data and generates data chips. A transmitter 266 conditions the data chips and generates a downlink signal, which is transmitted via antenna 252 to terminal 132 and other terminals.

At terminal 132, antenna 230 receives the downlink signal from access point 122 and provides a received signal to a receiver 218. Receiver 218 conditions the received signal and provides samples. Data processor 212 processes the samples and provides decoded traffic data to a data sink 204 and decoded signaling data to controller/processor 240.

For Bluetooth operation, data to send to Bluetooth device 134 is provided by a data source 206, processed by a data processor 222, conditioned by a transmitter 226, and transmitted via antenna 230 to Bluetooth device 134, which may be earpiece 134a or mouse 134b in FIG. 1. Bluetooth device 134 receives and processes the signal from terminal 132 to recover the transmitted data. Bluetooth device 134 also processes data to send to terminal 132 and transmits a signal to terminal 132. At terminal 132, the signal from Bluetooth device 134 is received by antenna 230, conditioned by a receiver 228, and processed by data processor 222 to recover the data sent by Bluetooth device 134. A memory 224 stores data and program codes for Bluetooth module 220. Bluetooth device 134 may include processing units similar to those shown in FIG. 2 for access point 122.

Controllers/processors 240 and 270 direct the operation at terminal 132 and access point 122, respectively. Memories 242 and 272 store data and program codes for terminal 132 and access point 122, respectively. Scheduler 274 performs scheduling for terminal 132 and other terminals communicating with access point 122.

Terminal 132 may utilize WLAN module 210 to communicate with WLAN 120, e.g., for a Voice-over-Internet Protocol (VoIP) call or a packet data call. Terminal 132 may utilize Bluetooth module 220 to communicate with a Bluetooth device, e.g., earpiece 134. For example, cellular phone 132a may exchange VoIP packets with WLAN 120 and may forward the VoIP packets to earpiece 134a via Bluetooth. As another example, laptop computer 132b may exchange packet data with WLAN 120 and may also exchange command data with mouse 134b via Bluetooth.

WLAN module 210 and Bluetooth module 220 may be located in close proximity to one another and may share antenna 230, as shown in FIG. 2. WLAN module 210 and Bluetooth module 220 may also operate on the same frequency band, e.g., the ISM band from 2.4 to 2.4835 GHz. In this case, the transmission from one module may cause interference to the transmission for the other module.

In an aspect, graceful coexistence between WLAN and Bluetooth may be achieved by giving priority to a communication protocol having high priority data to send. WLAN module 210 may examine a packet to send and determine whether the packet contains high priority data. If the packet contains high priority data, then WLAN module 210 may request Bluetooth module 220 to not transmit on the wireless channel until the high priority data is sent. WLAN module 210 may also request Bluetooth module 220 to not transmit when the WLAN module expects to receive high priority data.

Correspondingly, Bluetooth module 220 may request WLAN module 210 to not transmit when the Bluetooth module has high priority data to send or receive. WLAN module 210 may then forgo transmission until the high priority data is sent or received by Bluetooth module 220. WLAN module 210 and Bluetooth module 220 may concurrently have high priority data to send or receive. A priority scheme may be used to determine which module will gain control of the wireless channel in such a situation. For example, WLAN module 210 may be granted higher priority than Bluetooth module 220, and Bluetooth module 220 may forgo transmission whenever a conflict arises.

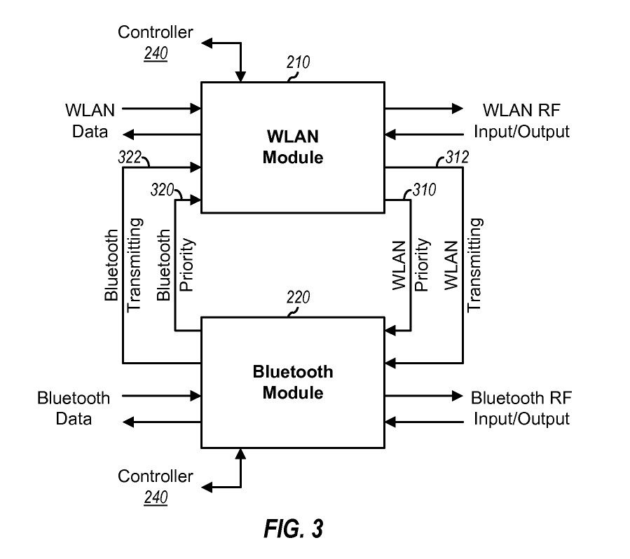

FIG. 3 shows a block diagram of a design of communication between WLAN module 210 and Bluetooth module 220. In this design, each module has two lines going to the other module. WLAN module 210 may assert a WLAN priority line 310 when it desires control of the wireless channel, e.g., when WLAN module 210 has priority data to send or receive. WLAN module 210 may assert a WLAN transmitting line 312 when it is transmitting on the wireless channel. Similarly, Bluetooth module 220 may assert a Bluetooth priority line 320 when it desires control of the wireless channel, e.g., when Bluetooth module 220 has priority data to send or receive. Bluetooth module 220 may assert a Bluetooth transmitting line 322 when it is transmitting on the wireless channel. Lines 310, 312, 320 and 322 may also go to other modules within terminal 132. For example, controller/processor 240 may receive lines 310 to 322 and control the operation of the WLAN and/or Bluetooth modules based on how often conflicts arise between these two modules.

In one design, WLAN module 210 has higher priority than Bluetooth module 220 in case of a conflict. Prior to transmitting, WLAN module 210 may check Bluetooth lines 320 and 322 to ensure that neither of these two lines is asserted by Bluetooth module 220. If Bluetooth lines 320 and 322 are not asserted, then WLAN module 210 may assert WLAN transmitting line 312 and start transmitting on the wireless channel. If either Bluetooth line 320 and/or 322 is asserted, then WLAN module 210 may assert WLAN priority line 310 and then wait for Bluetooth module 220 to relinquish the wireless channel before transmitting in order to avoid collision between WLAN and Bluetooth transmissions.

To gain control of the wireless channel, e.g., to send or receive priority data, WLAN module 210 may assert WLAN priority line 310 and then monitor Bluetooth lines 320 and 322. If Bluetooth module 220 is currently transmitting on the wireless channel, then Bluetooth module 220 may either stop transmitting immediately or finish the current transmission. Bluetooth module 220 may then (e.g., immediately) de-assert Bluetooth lines 320 and 322 and relinquish the wireless channel. WLAN module 210 may obtain control of the wireless channel when Bluetooth lines 320 and 322 are de-asserted and may retain control of the wireless channel until it de-asserts WLAN lines 310 and 312.

Prior to transmitting, Bluetooth module 220 may check WLAN lines 310 and 312 to ensure that neither of these two lines is asserted by WLAN module 210. If WLAN lines 310 and 312 are not asserted, then Bluetooth module 220 may assert Bluetooth transmitting line 322 and start transmitting on the wireless channel. Bluetooth module 220 may continue to monitor WLAN priority line 310 while it is transmitting and may terminate transmission if line 310 is asserted. Bluetooth module 220 may also check WLAN lines 310 and 312 whenever it desires control of the wireless channel, e.g., to send or receive priority data. Bluetooth module 220 may assert Bluetooth priority line 320 if WLAN lines 310 and 312 are not asserted.

Alternatively, Bluetooth module 220 may have higher priority than WLAN module 210 in case of a conflict. The operation described above may then be applied in reverse for WLAN module 210 and Bluetooth module 220.

FIG. 3 shows one design in which each module has two lines going to the other module. In another design, each module has one line going to the other module. The line from each module may indicate whether that module is transmitting and/or desires control of the wireless channel, e.g., to send or receive priority data. In yet another design, a single line couples between the WLAN and Bluetooth modules and is shared by both modules, e.g., in a time division multiplexed (TDM) manner.

In yet another design, WLAN module 210 and Bluetooth module 220 may communicate via a synchronization mechanism such as a shared memory, a remote procedure call (RPC), etc. This design may be used when multiple processors are involved. In yet another design, a device may implement both WLAN module 210 and Bluetooth module 220 and may include an embedded central processing unit (CPU) that can control both modules 210 and 220. In this design, the synchronization of transmit or receive operation of each of modules 210 and 220 may be performed by the CPU.

In general, the WLAN and Bluetooth modules may communicate via any number of means and may exchange any type of information such as, e.g., whether a module is transmitting, desires control of the wireless channel, etc.

The priority of data to send may be ascertained in various manners. In one design, the priority of data is determined by examining the header of one or more protocol data units in one or more layers in a protocol stack. The protocol stack may include an application layer, a transport layer, a network layer, a link layer, and a physical layer. Terminal 132 may communicate with another terminal or a server using HyperText Transfer Protocol (HTTP), File Transfer Protocol (FTP), Real-time Transport Protocol (RTP), Session Initiation Protocol (SIP), Session Description Protocol (SDP), and/or other protocols at the application layer. HTTP supports transfer of information on the World Wide Web and is commonly used to publish and retrieve HTLM pages. FTP supports transfer of files between two entities and is commonly used to download data, files, etc. RTP provides end-to-end network transport functions and is suitable for applications sending real-time data such as voice, video, etc. SIP is a signaling protocol for creating, modifying, and terminating sessions for VoIP, multimedia, etc. SDP is a signaling protocol for describing multimedia sessions.

Application layer data may be sent using Transmission Control Protocol (TCP), User Datagram Protocol (UDP), and/or other protocols at the transport layer. Transport layer data may be sent using IP version 4 (IPv4) or IP version 6 (IPv6) at the network layer. The link and physical layers for WLAN module 210 may be IEEE 802.11, 802.11b, 802.11g, etc. The link and physical layers for Bluetooth module 220 may be Bluetooth.

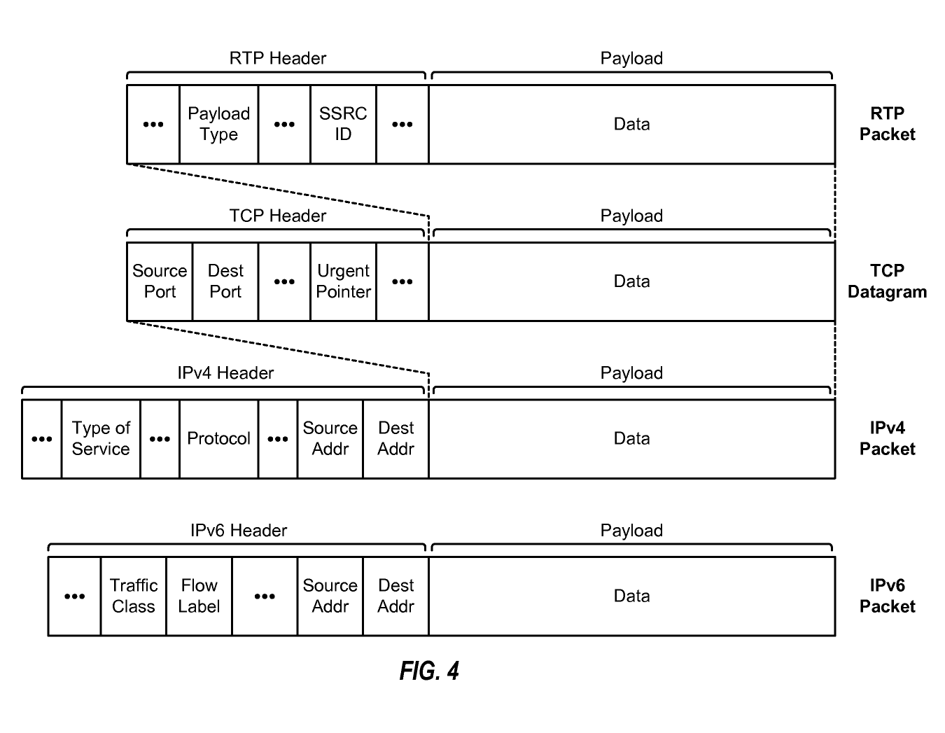

FIG. 4 shows data encapsulation for sending data using RTP at the application layer, TCP at the transport layer, and IPv4 or IPv6 at the network layer. For RTP, data from an application is sent in RTP packets. Each RTP packet includes a header and a payload. The RTP header has various fields including a payload type field and a synchronization source identifier (SSRC ID) field. The payload type field identifies the format of the RTP payload and determines its interpretation by the application. The SSRC field identifies a synchronization source (or sender) among different streaming sources in a conference call. Application data may be sent in the RTP payload. RTP is described in RFC 3550, entitled “RTP: A Transport Protocol for Real-Time Applications,” July 2003, which is publicly available.

RTP packets may be sent in TCP datagrams. Each TCP datagram includes a header and a payload. The TCP header has various fields including a source port field, a destination port field, and an urgent pointer field. The source port field indicates the port number for the sender of the TCP datagram. The destination port field indicates the port number of the intended recipient of the TCP datagram. The urgent pointer field conveys the current value of an urgent pointer, which points to the sequence number of the octet following urgent data. RTP packets may be sent in the TCP payload. TCP is described in RFC 793, entitled “Transmission Control Protocol,” September 1981, which is publicly available.

TCP datagrams may be sent in IPv4 packets. Each IPv4 packet includes a header and a payload. The IPv4 header has various fields including a type of service (TOS) field, a protocol field, a source address field, and a destination address field. The type of service field indicates how the IPv4 packet should be treated, e.g., with low delay, high reliability, etc. The protocol field identifies the protocol used in the payload, which is TCP in the example shown in FIG. 4. The source address field contains an IPv4 address for the sender of the IPv4 packet. The destination address field contains an IPv4 address for the intended recipient of the IPv4 packet. The TCP datagrams may be sent in the IP payload. IPv4 is described in RFC 791, entitled “Internet Protocol,” September 1981, which is publicly available.

TCP datagrams may also be sent in IPv6 packets. Each IPv6 packet includes a header and a payload. The IPv6 header has various fields including a traffic class field, a flow label field, a source address field, and a destination address field. The traffic class field may be used to identify and distinguish between different classes or priorities of IPv6 packets. The flow label field may be used by a sender to label sequences of packets for which special handling (e.g., non-default quality of service or real-time service) by routers is requested. The source address field contains an IPv6 address for the sender of the IPv6 packet. The destination address field contains an IPv6 address for the intended recipient of the IPv6 packet. The TCP datagrams may be sent in the IP payload. IPv6 is described in RFC 2460, entitled “Internet Protocol, Version 6 (IPv6),” December 1998, which is publicly available.

WLAN module 210 may examine any field in any protocol data unit to determine the priority of data to send. For example, WLAN module 210 may examine the type of service field and/or the protocol field in an IPv4 packet, the traffic class field and/or the flow label field in an IPv6 packet, the urgent pointer field in a TCP datagram, the payload type field in an RTP packet, etc. From these fields, WLAN module 210 may be able to determine data type and/or other information indicative of the priority of the data to send. For example, high priority data may be sent using TCP and low priority data may be sent using UDP. Data for TCP may be identified by examining the protocol field in the header of IPv4 packets.

Alternatively or additionally, WLAN module 210 may examine the source and/or destination fields in an IPv4 packet, an IPv6 packet, a TCP datagram, an RTP packet, etc. The source and/or destination fields may convey information indicative of the priority of the data to send. For example, an RTP flow carrying priority data may be sent using a particular port number. Data for this RTP flow may be identified based on the source port field in the header of TCP datagrams. As another example, a SIP flow carry important signaling may be sent using another port number. Signaling data for this SIP flow may be identified by examining the source port field in the header of TCP datagrams.

FIG. 4 shows some header fields of some data protocols that may be used to send data. Other header fields and/or other data protocols may also be used to determine the priority of data to send.

The priority of data to send may also be ascertained in other manners. For example, an application originating the data or a controller/processor processing the data may indicate the priority of the data. Certain types of data may have high priority whereas other types of data may have low priority. For example, signaling data (e.g., for SIP or acknowledgement) and certain traffic data (e.g., for real-time service) may have high priority and may be sent without delay. Other traffic data (e.g., for background downloading) may have lower priority and may be sent with delay if the wireless channel is occupied. The wireless channel may be considered as being occupied by a module if that module is transmitting on the wireless channel or has gained control of the wireless channel, e.g., by asserting the priority line for that module.

A module may determine whether it may receive high priority data in several manners. For Bluetooth, the transmit and receive slots are synchronized between the different Bluetooth devices in a WPAN. A given Bluetooth device may then know when to receive data but may not know what type of data will be received. The received data type may be assumed based on the type of session established for the Bluetooth device. For example, if there is a voice session, such as when a hands-free kit is being used, then the received data may be assumed to be voice data. The same may be applied for WLAN. However, since there is a random access to the wireless medium in WLAN, a WLAN receiver may not know when or from which WLAN station data will be received. Traffic (e.g., for voice) may be scheduled in WLAN using scheduled automatic power save delivery (S-APSD) and unscheduled APSD (U-APSD), which are supported by IEEE 802.11e. For both Bluetooth and WLAN, a device may assume symmetric operation and/or periodic operation and, based on that assumption, may guess the priority of the data to be received.

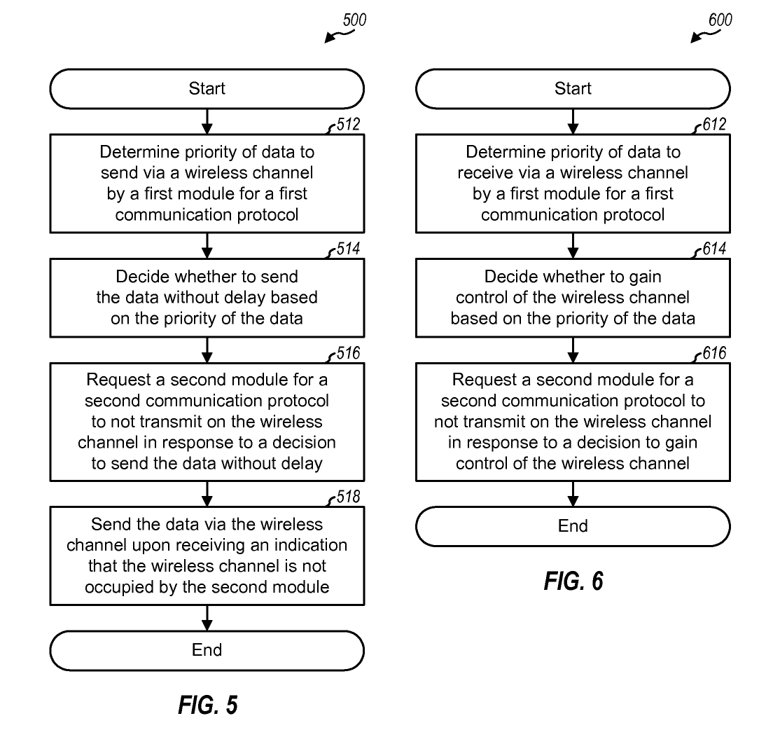

FIG. 5 shows a design of a process 500 for sending data. Priority of data to send via a wireless channel by a first module for a first communication protocol may be determined (block 512). Whether to send the data without delay may be decided based on the priority of the data (block 514). A second module for a second communication protocol may be requested to not transmit on the wireless channel in response to a decision to send the data without delay (block 516). The data may be sent via the wireless channel upon receiving an indication that the wireless channel is not occupied by the second module (block 518). The first communication protocol may be for WLAN, e.g., 802.11 or some other communication protocol. The second communication protocol may be for WPAN, e.g., Bluetooth or some other communication protocol.

For block 512, the priority of the data to send may be determined in various manners. In one design, the priority of the data is determined based on data type. A determination may be made whether the data is for signaling or traffic. The data may be sent (i) without delay if it is for signaling or (ii) with delay if it is for traffic and the wireless channel is currently occupied by the second module. In another design, the priority of the data is determined by examining at least one header field for at least one data protocol used for the data, e.g., any one or any combination of the fields shown in FIG. 4. In yet another design, the priority of the data is received from an application originating the data. The priority of the data may also be determined in other manners.

For block 514, a priority line for the first module may be asserted to request the second module to not transmit on the wireless channel. The request may also be sent in other manners with other signals and/or messages.

For block 516, if the wireless channel is currently occupied by the second module, then the data may be sent via the wireless channel upon receiving an indication that the second module no longer occupies the wireless channel. If the wireless channel is not currently occupied by the second module, then a transmitting line for the first module may be asserted to inform the second module that the first module is transmitting, and the data may be sent via the wireless channel. Regardless of its priority, the data may be sent without delay if the wireless channel is currently not occupied by the second module. If the decision to send the data without delay is not made, then transmission of the data may be delayed if the wireless channel is currently occupied by the second module. The data may be sent after receiving an indication that the second module no longer occupies the wireless channel, or may even be discarded.

FIG. 6 shows a design of a process 600 for receiving data. The priority of data to receive via a wireless channel by a first module for a first communication protocol may be determined, e.g., based on data type, an application expecting the data, etc. (block 612). Whether to gain control of the wireless channel may be decided based on the priority of the data (block 614). A second module for a second communication protocol may be requested to not transmit on the wireless channel in response to a decision to gain control of the wireless channel (block 616). A priority line for the first module may be asserted to request the second module to not transmit on the wireless channel. The first communication protocol may be 802.11 or some other communication protocol. The second communication protocol may be Bluetooth or some other communication protocol.

The techniques described herein may be implemented by various means. For example, these techniques may be implemented in hardware, firmware, software, or a combination thereof. For a hardware implementation, the processing units used to perform the techniques may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

For a firmware and/or software implementation, the techniques may be implemented with modules (e.g., procedures, functions, etc.) that perform the functions described herein. The firmware and/or software instructions may be stored in a memory (e.g., memory 214, 224, or 242 in FIG. 2) and executed by a processor (e.g., processor 212, 222, or 240). The memory may be implemented within the processor or external to the processor. The firmware and/or software instructions may also be stored in other processor-readable medium such as random access memory (RAM), read-only memory (ROM), non-volatile random access memory (NVRAM), programmable read-only memory (PROM), electrically erasable PROM (EEPROM), FLASH memory, compact disc (CD), magnetic or optical data storage device, etc.

An apparatus implementing the techniques described herein may be a stand-alone unit or may be part of a device. The device may be (i) a stand-alone integrated circuit (IC), (ii) a set of one or more ICs that may include memory ICs for storing data and/or instructions, (iii) an ASIC such as a mobile station modem (MSM), (iv) a module that may be embedded within other devices, (v) a cellular phone, wireless device, handset, or mobile unit, (vi) etc.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus comprising:
a processor configured to determine priority of data to send via a wireless channel by a first module for a first communication protocol, to decide whether to send the data without delay based on the priority of the data, and to request a second module for a second communication protocol to not transmit on the wireless channel in response to a decision to send the data without delay; and
a memory coupled to the processor.

2. The apparatus of claim 1, wherein the processor is configured to determine whether the data is for signaling or traffic and to make the decision to send the data without delay if the data is for signaling.

3. The apparatus of claim 2, wherein the processor is configured to delay sending the data if the data is for traffic and the wireless channel is currently occupied by the second module.

4. The apparatus of claim 1, wherein the processor is configured to examine at least one header field for at least one data protocol used for the data to determine the priority of the data.

5. The apparatus of claim 4, wherein the at least one header field comprises at least one of a type of service field and a protocol field in Internet Protocol version 4 (IPv4), a traffic class field and a flow label field in IP version 6 (IPv6), and a source port field, a destination port field, and an urgent pointer field in Transmission Control Protocol (TCP).

6. The apparatus of claim 1, wherein the processor is configured
to receive the priority of the data from an application originating the data.

7. The apparatus of claim 1, wherein the processor is configured to assert a priority line for the first module to request the second module to not transmit on the wireless channel.

8. The apparatus of claim 1, wherein in response to the decision to send the data without delay the processor is configured to assert a priority line for the first module if the wireless channel is currently occupied by the second module, and to send the data via the wireless channel upon receiving an indication that the second module no longer occupies the wireless channel.

9. The apparatus of claim 1, wherein in response to the decision to send the data without delay the processor is configured to assert a transmitting line for the first module if the wireless channel is not currently occupied by the second module, and to send the data via the wireless channel.

10. The apparatus of claim 1, wherein the processor is configured
to send the data without delay, regardless of the priority of the data, if the wireless channel is currently not occupied by the second module.

11. The apparatus of claim 1, wherein the processor is configured to delay sending the data if the wireless channel is currently occupied by the second module and the decision to send the data without delay is not made.

12. The apparatus of claim 11, wherein the processor is configured to receive an indication that the second module no longer occupies the wireless channel, and to send the data after receiving the indication.

13. The apparatus of claim 1, wherein the processor is configured to communicate with the second module via a synchronization mechanism.

14. The apparatus of claim 13, wherein the synchronization mechanism comprises a shared memory or a remote procedure call (RPC).

15. The apparatus of claim 1, wherein the first communication protocol is for wireless local area network (WLAN) and the second communication protocol is for personal local area network (WPAN).

16. The apparatus of claim 1, wherein the first communication protocol is IEEE 802.11 and the second communication protocol is Bluetooth.

17. A method comprising:
determining priority of data to send via a wireless channel by a first module for a first communication protocol;
deciding whether to send the data without delay based on the priority of the data; and
requesting a second module for a second communication protocol to not transmit on the wireless channel in response to a decision to send the data without delay.

18. The method of claim 17, wherein the determining the priority of the data comprises determining whether the data is for signaling or traffic, and wherein the deciding whether to send the data without delay comprises making the decision to send the data without delay if the data is for signaling.

19. The method of claim 17, wherein the requesting the second module to not transmit on the wireless channel comprises asserting a priority line for the first module if the wireless channel is currently occupied by the second module, and wherein the method further comprises:
sending the data via the wireless channel upon receiving an indication that the second module no longer occupies the wireless channel.

20. The method of claim 17, further comprising:
asserting a transmitting line for the first module if the wireless channel is not currently occupied by the second module; and
sending the data via the wireless channel.

21. The method of claim 17, further comprising:
delaying sending the data if the wireless channel is currently occupied by the second module and the decision to send the data without delay is not made; and
sending the data after receiving an indication that the second module no longer occupies the wireless channel.

22. An apparatus comprising:
means for determining priority of data to send via a wireless channel by a first module for a first communication protocol;
means for deciding whether to send the data without delay based on the priority of the data; and
means for requesting a second module for a second communication protocol to not transmit on the wireless channel in response to a decision to send the data without delay.

23. The apparatus of claim 22, wherein the means for determining the priority of the data comprises means for determining whether the data is for signaling or traffic, and wherein the means for deciding whether to send the data without delay comprises means for making the decision to send the data without delay if the data is for signaling.

24. The apparatus of claim 22, wherein the means for requesting the second module to not transmit on the wireless channel comprises means for asserting a priority line for the first module if the wireless channel is currently occupied by the second module, and wherein the apparatus further comprises:
means for sending the data via the wireless channel upon receiving an indication that the second module no longer occupies the wireless channel.

25. The apparatus of claim 22, further comprising:
means for asserting a transmitting line for the first module if the wireless channel is not currently occupied by the second module; and
means for sending the data via the wireless channel.

26. The apparatus of claim 22, further comprising:
means for delaying sending the data if the wireless channel is currently occupied by the second module and the decision to send the data without delay is not made; and
means for sending the data after receiving an indication that the second module no longer occupies the wireless channel.

27. A processor-readable media for storing instructions to:
determine priority of data to send via a wireless channel by a first module for a first communication protocol;
decide whether to send the data without delay based on the priority of the data; and
request a second module for a second communication protocol to not transmit on the wireless channel in response to a decision to send the data without delay.

28. An apparatus comprising:
a first module configured to send data via a wireless channel based on a first communication protocol; and
a second module configured to send data via the wireless channel based on a second communication protocol, and wherein the first module receives data to send via the wireless channel, determines priority of the data, decides whether to send the data without delay based on the priority of the data, and requests the second module to not transmit on the wireless channel in response to a decision to send the data without delay.

29. The apparatus of claim 28, wherein the first module asserts a priority line for the first module if the wireless channel is currently occupied by the second module and sends the data via the wireless channel upon receiving an indication that the second module no longer occupies the wireless channel.

30. The apparatus of claim 28, wherein the second module terminates any pending transmission upon receiving the request from the first module to not transmit on the wireless channel.

31. The apparatus of claim 28, wherein the first module asserts a transmitting line for the first module if the wireless channel is not currently occupied by the second module and sends the data via the wireless channel.

32. An apparatus comprising:
a processor configured to determine priority of data to receive via a wireless channel by a first module for a first communication protocol, to decide whether to gain control of the wireless channel based on the priority of the data, and to request a second module for a second communication protocol to not transmit on the wireless channel in response to a decision to gain control of the wireless channel; and
a memory coupled to the processor.

33. The apparatus of claim 32, wherein the processor is configured to determine whether the data is for signaling or traffic and to make the decision to gain control of the wireless channel if the data is for signaling.

34. The apparatus of claim 32, wherein the processor is configured to assert a priority line for the first module to request the second module to not transmit on the wireless channel.

35. The apparatus of claim 32, wherein the first communication protocol is IEEE 802.11 and the second communication protocol is Bluetooth.

36. A method comprising:
determining priority of data to receive via a wireless channel by a first module for a first communication protocol;
deciding whether to gain control of the wireless channel based on the priority of the data; and
requesting a second module for a second communication protocol to not transmit on the wireless channel in response to a decision to gain control of the wireless channel.

37. The method of claim 36, wherein the determining the priority of the data comprises determining whether the data is for signaling or traffic, and wherein the deciding whether to gain control of the wireless channel comprises making the decision to gain control of the wireless channel if the data is for signaling.
